(19) United States
(12) Patent Application Publication
(10) Pub. No.: US 2002/0057818 A1
(43) Pub. Date: May 16, 2002

(54) Speaker apparatus

(76) Inventors: Yasuhisa Abe, Tendo-shi (JP); Fumio Murayama, Tendo-shi (JP); Koji Matsumoto, Tendo-shi (JP); Koji Takayama, Tendo-shi (JP)

Correspondence Address: MORGAN LEWIS & BOCKIUS LLP, 1111 PENNSYLVANIA AVENUE NW, WASHINGTON, DC, 20004, US

(21) Appl. No.: 09/984,025

(22) Filed: Oct. 26, 2001

(30) Foreign Application Priority Data
Oct. 31, 2000 (JP) 2000-332299

(51) Int. Cl. H04R 1/00

(52) U.S. Cl. 381/396

(57) ABSTRACT

The present invention relates to a speaker that has a reduced number of parts and effectively emits heat of a voice coil to the outside of the speaker. The speaker includes a diaphragm, a bobbin connected to the diaphragm, a voice coil supported by the bobbin, a center cap for covering an end of the bobbin, and a magnetic circuit for applying a magnetic field to the voice coil. The bobbin and center cap are integrally fabricated.

### BACKGROUND OF THE INVENTION

1. Field of the Invention

The present invention relates to a speaker apparatus having a cone-shaped diaphragm.

2. Description of the Related Art

Referring to FIG. 1 of the accompanying drawings, illustrated is a conventional speaker apparatus that has a cone-shaped diaphragm.

This speaker apparatus includes a back plate 1 that has a pole piece 2 extending upwards from a center portion thereof, and a magnet 3 that is located on an annular support portion of the back plate 1. A top plate 4 is placed on the magnet 3 such that a magnetic gap is created between the top plate 4 and pole piece 2. A bobbin 6 that supports a voice coil 5 is positioned in the magnetic gap. The voice coil bobbin 6 is supported by a frame 8 via a damper 7 such that it can oscillate. A center portion of a cone-shaped diaphragm 9 is connected to the voice coil bobbin 6. A conical center cap 10 is provided at a top of the voice coil bobbin 6. The center cap 10 and voice coil bobbin 6 are separate members.

The voice coil 5 vibrates (oscillates) together with the bobbin 6 in response to a sound/voice signal current supplied to the voice coil 5. This in turn vibrates the cone-shaped diaphragm 9 and generates a sound.

The sound/voice signal current flows in the voice coil 5 so that heat is generated in the voice coil 5. As a result, the temperature of the magnetic gap may exceed an upper limit value, and the voice coil 5 may be burned and/or damaged.

### SUMMARY OF THE INVENTION

The present invention was developed to solve the above described problems, and an object of the present invention is to provide a speaker apparatus in which the voice coil is not subject to a very high temperature environment so that voice coil temperature does not rise to an extremely high value.

According to one aspect of the present invention, there is provided a speaker apparatus including a diaphragm, a bobbin connected to the diaphragm, a voice coil supported by the bobbin, a center cap for covering an end of the bobbin, and a magnetic circuit for applying a magnetic field to the voice coil, wherein the voice coil bobbin and center cap are made integral.

### BRIEF DESCRIPTION OF THE DRAWINGS

FIG. 1 illustrates a cross sectional view of a conventional speaker apparatus;

FIG. 2 illustrates a cross sectional view of a speaker apparatus according to a first embodiment of the present invention; and

FIG. 3 illustrates a perspective view of a bobbin and a center cap employed in a second embodiment of the present invention.

### DETAILED DESCRIPTION OF THE INVENTION

Embodiments of the present invention will be described in reference to the accompanying drawings.

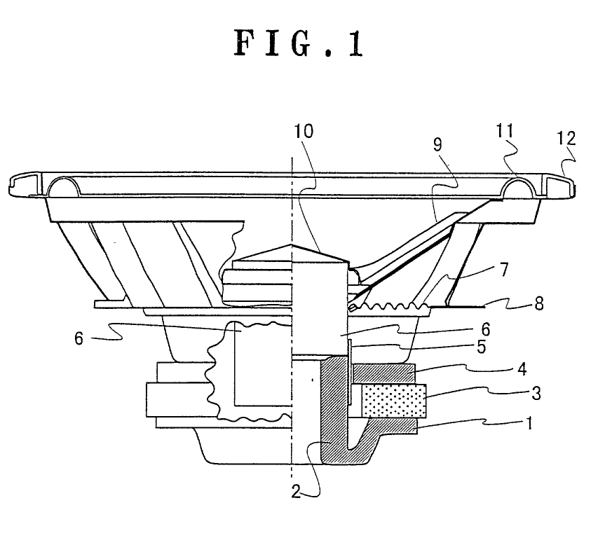

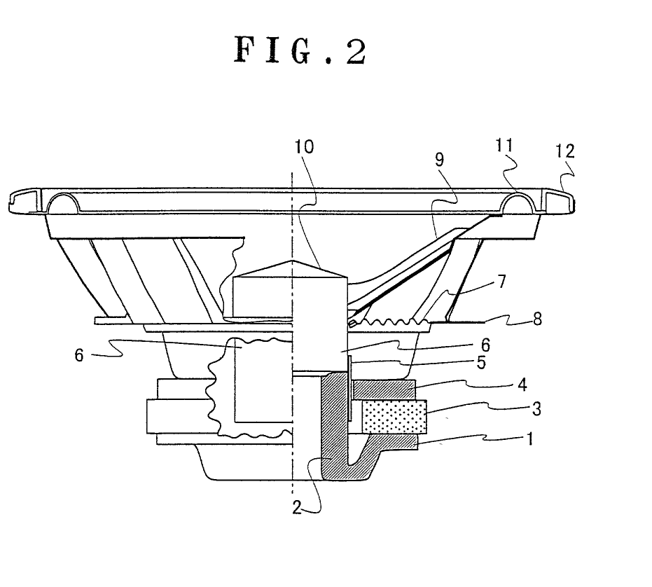

FIG. 2 illustrates a speaker apparatus according to a first embodiment of the invention, and similar reference numerals are used to designate similar elements in FIGS. 1 and 2.

As shown in FIG. 2, a back plate 1 of the speaker apparatus has a pole piece 2 extending upwards from a center portion of the back plate 1, and a magnet 3 is located on an annular support portion of the back plate 1. A top plate 4 is placed on the magnet 3 such that a magnetic gap is formed between the top plate 4 and pole piece 2. A bobbin 6 that supports a voice coil 5 is positioned to oscillate in the magnetic gap. In order to effectively use a magnetic flux in the magnetic gap and increase an efficiency, the voice coil 5 is wound around the bobbin 6 such that the height of the voice coil becomes greater than the magnetic gap. The voice coil bobbin 6 is supported by a frame 8 via a damper 7. The voice coil bobbin 6 is made from a material, such as aluminum, which has good heat transfer characteristics in order to sufficiently emit heat generated from the voice coil 5. A center portion of a cone-shaped diaphragm 9 is connected to the voice coil bobbin 6. A conical center cap 10 is provided at a top of the bobbin 6. The center cap 10 is made integral with the bobbin 6. By integrally fabricating the bobbin 6 and center cap 10 made from a material having a good heat transfer coefficient such as aluminum, heat of the voice coil 5 can be efficiently emitted outside the speaker through the bobbin 6 and center cap 10. By making the bobbin 6 and center cap 10 integral, the number of the parts in the speaker apparatus is reduced. An upper periphery of the cone-shaped diaphragm 9 is supported at an edge 11 firmly secured to the frame 8 via a gasket 12.

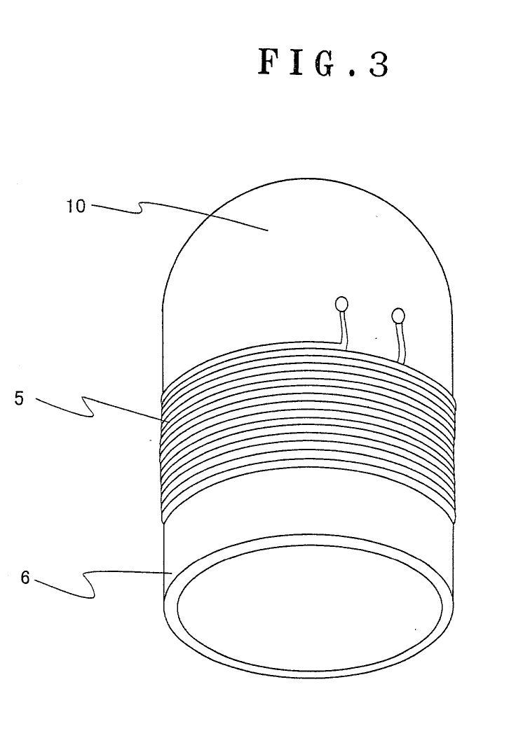

Referring to FIG. 3, illustrated are the bobbin 6 and center cap 10 according to a second embodiment of the present invention. The center cap 10 is integral with the bobbin 6 and has a dome shape. The dome-shaped center cap is easy to mold. Like the first embodiment, the number of the parts is reduced by integrally fabricating the center cap 10 and bobbin 6, if compared with a structure in which the center cap and bobbin are fabricated separately.

As understood from the foregoing description, since the bobbin and center cap are integrally molded, the number of the parts is reduced and a good heat emission property is ensured.

This application is based on Japanese Patent Application No. 2000-332299, and the entire disclosure thereof is incorporated herein by reference.

What is claimed is:

1. A speaker apparatus comprising:
a diaphragm;
a bobbin connected to the diaphragm;
a voice coil supported by the bobbin;
a center cap for covering an end of the bobbin; and
a magnetic circuit for applying a magnetic field to the voice coil, wherein the bobbin and center cap are integrally formed.

2. The speaker apparatus according to claim 1, wherein the bobbin and center cap are made from a material having good thermal transfer characteristics.

3. The speaker apparatus according to claim 2, wherein the bobbin and center cap are made from aluminum.
